(19) United States
(12) Patent Application Publication
(10) Pub. No.: US 2003/0146033 A1
(43) Pub. Date: Aug. 7, 2003

(54) Apparatus for controlling electrical attachments on ATV'S

(76) Inventor: Harold Wayne Malmstrom, Manitowoc, WI (US)

Correspondence Address: Harold W. Malmstrom, 8704 Arrow Rd., Manitowoc, WI, 54220, US

(21) Appl. No.: 10/074,638

(22) Filed: Feb. 4, 2002

(51) Int. Cl. B60K 17/34

(52) U.S. Cl. 180/233

(57) ABSTRACT

An apparatus for controlling electrical attachments on ATV'S with An embodiment containing an electrical switch or switches, A means of attaching to ATV, A means of replacing existing control attachments on ATV, A means of protecting the switch or switches from the elements of weather, A means of attaching to ATV that will withstand the rigors of ATV usage, and An means of embodiment sufficient in size to contain switch of sufficient capacity to operate attachments.

### BACKGROUND OF THE INVENTION

This invention relates generally to the field of All Terrain Vehicles, and more particularly to an apparatus for controlling electrical attachments on ATV's.

The need for a device to control attachments or devices on ATVS has long been needed.

This invention specifically addresses the need for an apparatus to control attachments and devices that is safe, ergonomic ally pleasing and fits the use.

With advent of the ATV or All Terrain Vehicle, the use has become so varied that people everywhere are using them for various tasks through the world. From playing and riding to being their money making apparatus, even the military are using them for their operations.

Some of the uses would be:

Snow plowing for commercial and home use

Landscaping for commercial and home use

Military special operations

Forest service patrols

Police patrols on beaches and hard to reach areas

Fire fighting operations

Inspections of electrical lines in remote areas

Inspections of oil and gas lines, pumping stations

Inspection of communication towers in remote locations

Surveying in remote or rough terrain locations

In all of these cases some form of electrical attachment or device may be used. These devices may be used while the vehicle is in motion or at rest.

In the use of some devices the electrical capacity of the switching device has to be large, maybe 75 AMPS, or more, causing the embodiment that houses the switching device to become very large and comber some. This dictates that the mounting location be in a very non ergonomic position on the vehicle.

There has become a very large market for the use of ATV'S with electrical attachments and devices.

There needed to be a convenient and practical way of operating these attachments and devices while in the ATV operating position, hence the Converta-Switch.

The prior technology for controlling these devices and attachments was to mount a very large and non-ergonomic switch apparatus somewhere on the ATV. It may be mounted on the fender, maybe mounted on the rack of ATV, maybe mounted on the treble clamp or even the middle of the fuel tank cover, not very safe location.

The prior technology lacked any consideration for ergonomics, looks or application.

The prior technology lacked the convenience of operation, had a degrading appearance for the vehicle and it lacked versatility of operation.

Prior technology was very hard to operate because of the means it had to attached and the location. The operator had to remove their hand from the control means of the vehicle to operate the device or attachment, causing an unsafe situation.

Prior technology was only applicable to the device it was intended for or supplied with. If the device was adapted for other uses the capacity may not be sufficient to operate the device or attachment and would fail.

### SUMMARY OF THE INVENTION

The primary object of the invention is To provide a means of controlling electrical attachments on an ATV.

Another object of the invention is To provide a ergonomic means of controlling electrical attachments on an ATV.

Another object of the invention is To provide a safe means of controlling electrical attachments on an ATV.

A further object of the invention is To provide a weather proof means of controlling electrical attachments on an ATV.

Yet another object of the invention is To provide a means of controlling electrical attachments without removing hand from control means of ATV.

Still yet another object of the invention is To provide a means of controlling electrical attachments while replacing a means of attaching other control means on ATV.

Another object of the invention is To provide a means of controlling electrical attachments such as winch's, snow plows, blades, plows, mowers, post pullers.

Other objects and advantages of the present invention will become apparent from the following descriptions, taken in connection with the accompanying drawings, wherein, by way of illustration and example, an embodiment of the present invention is disclosed.

An apparatus for controlling electrical attachments on ATV's comprising: An embodiment containing an electrical switch or switches, A means of attaching to ATV, A means of replacing existing control attachments on ATV, A means of protecting the switch or switches from the elements of weather, A means of attaching to ATV that will withstand the rigors of ATV usage, and A means of embodiment sufficient in size to contain switch of sufficient capacity to operate attachments.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a fragmented isometric view showing existing handle bar and control lever of an ATV.

FIG. 2 is a fragmented exploded isometric view showing existing handle bar with control lever retaining clamp and screws removed.

FIG. 3 is a fragmented isometric view the Converta Switch installed on handle bar.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

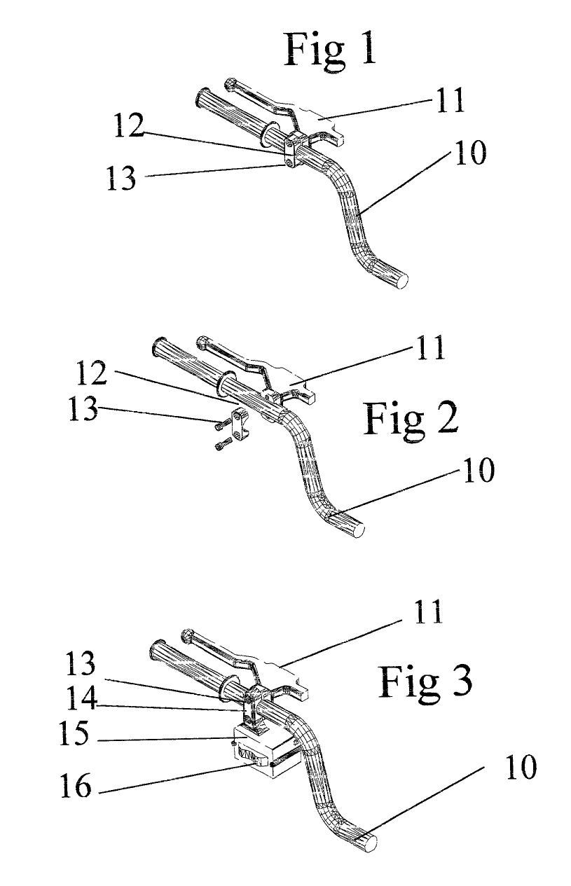

Turning to FIG. 1 shows a typical ATV handle bar 10 with control lever 11 installed on handle bar 10.

Returning to FIG. 1 showing the control lever 11 installed on the handle bar 10 with clamp 12 and screws 13 holding in position.

Turning to FIG. 2 shows a typical ATV handle bar 10 with control lever 11. The clamp 12 and screws 13 are in the exploded position showing the removal of such for the installation of the Converta Switch.

Turning to FIG. 3 shows a typical ATV handle bar 10 with control lever installed by using the Converta Switch clamp 14 and reusing the control lever clamp screws 13 to retain the Converta Switch Unit 15 and the switch with weather protection 16. The Converta Switch unit 15 conforms to the shape of the handle bar 10 for a built in look and profile.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for controlling electrical attachments on ATV'S comprising:
An embodiment containing an electrical switch or switches;
A means of attaching to ATV;
A means of replacing existing control attachments on ATV;
A means of protecting the switch or switches from the elements of weather;
A means of attaching to ATV that will withstand the rigors of ATV usage; and
A means of embodiment sufficient in size to contain switch of sufficient capacity to operate attachments.
